(19) United States
(12) Patent Application Publication
(10) Pub. No.: US 2026/0328476 A1
(43) Pub. Date: Oct. 22, 2026

(54) DRYING MATS

(71) Applicant: Direct Air Dryers Limited, Gillingham (GB)

(72) Inventors: David Kenneth Elliott, Rochester (GB); Jack Bernard Elliott, Brighton (GB)

(21) Appl. No.: 19/182,129

(22) Filed: Apr. 17, 2025

(51) Int. Cl. F26B 21/50

(52) U.S. Cl. CPC F26B 21/50

(57) ABSTRACT

An inflatable drying mat (1) and associated method for use with an air blower of the type having an air exhaust duct, the mat comprising a first, lower, half (la) having a plurality of exhaust perforations (7) through which air can be blown to dry floor or wall surfaces, and a substantially air impermeable second, upper, half (1b), the first half and the second half being connected together by a plurality of spacer straps (2) enabling the drying mat to retain a generally planar shape when inflated, the first half and the second half being connectable together around their peripheral edges by hook (5) and loop (6) strips for releasably sealing the peripheral edges of the mat while allowing access to the exhaust duct of the air blower to permit inflation of the mat, CHARACTERISED IN THAT the hook (5) and loop (6) strips along at least two adjoining peripheral edges (8a, 8b) of the mat are reversed along at least one opposite peripheral edge (8c, 8d) of the mat such that each half of the mat has at least two adjoining peripheral edges comprised of loops or hooks and the opposite peripheral edges comprised of hooks or loops, and the or each at least one opposite peripheral edge (8c, 8d) are on one or more respective pairs of sealable tongues (9), whereby to permit the loop and hook strips of the or each tongues to be folded back lengthwise to permit their insertion between the hook and loop strips of a peripheral edge portion of an adjacent such mat to thereafter permit the hook and loop strips to be pressed together to sealingly connect both mats and form a correspondingly larger composite mat, within which blown air is substantially uniformly distributed and evenly exhausted via their respective exhaust perforations.

### BACKGROUND OF THE INVENTION

This invention relates to the general subject of drying damp or waterlogged rooms within buildings that have suffered flood damage to the walls and floor.

With climate change there has been an increasing propensity for flooding of buildings which, in turn, has led to considerable inconvenience, damage to property and increases in insurance costs. Where the building is of conventional construction, such as having a solid floor and plaster walls, the drying process can be accelerated by the use of fan heaters within a closed room, although this is not a particularly efficient way of drying because as the air becomes hot and humid it is less able to absorb moisture, meaning that the saturated air within the room has to be regularly exhausted before a new drying cycle can commence, the cycle continuing, often for several days, before the room is suitably dry. On the other hand, if the room is permanently ventilated during the drying process, the or each fan heater can run continuously but much of the heat is lost to ambient and electrical energy is therefore wasted.

The foregoing problems have been addressed in part in GB2397366 (“D1”) in which inflatable mats similar to airbeds are provided with a large number of small ventilation apertures on one side, from which air can be expelled, the air being separately provided by an electrically operable air blower such as a fan heater of the type having an air exhaust duct. Each drying mat is in two parts and includes openable edge portions comprised of hook and loop connectors of the Velcro type which therefore permit insertion of the exhaust duct of the air blower at any chosen point, whereafter the Velcro permits the edges of the mat in this region to closely conform to the shape of the exhaust duct so as to provide an air seal to thereby maximise the airflow through the small ventilation apertures and hence maximise drying efficiency. Using this technique, warm air is directed where it is needed and the room can be left ventilated during the drying process, meaning that much less electrical energy is used even though the overall drying time for the room is greatly reduced. Multiple mats can be pneumatically connected together by the use of a flexible tube or collar having Velcro on the outside which can be inserted between the edge portions of the mats such that when one mat is inflated by the air blower, air also flows through the collar and into the next mat. This has the advantage in that only one air blower is required but in practice it is found that even where only two drying mats are connected together in this manner, the drying mat furthest from the air blower receives less air than the drying mat to which the air blower is directly connected. In addition, the air in the second drying mat is unevenly distributed, such that drying of the floor or wall surface is uneven. Another disadvantage is that there is an elongate “blind” strip where the two mats butt together due to the presence of their respective edges, where no air flows and where corresponding damp strips are left when the mats are removed after the drying process is complete.

### SUMMARY OF THE INVENTION

The present invention is derived from the realisation that there is a need for an improved apparatus for drying damp or waterlogged rooms in which the foregoing disadvantages are obviated.

According to the invention there is provided nn inflatable drying mat for use with an air blower of the type having an air exhaust duct, the mat comprising a first, lower, half having a plurality of exhaust perforations through which air can be blown to dry floor or wall surfaces, and a substantially air impermeable second, upper, half, the first half and the second half being connected together by a plurality of spacer straps enabling the drying mat to retain a generally planar shape when inflated, the first half and the second half being connectable together around their peripheral edges by hook and loop strips for releasably sealing the peripheral edges of the mat while allowing access to the exhaust duct of the air blower to permit inflation of the mat, CHARACTERISED IN THAT the hook and loop strips along at least two adjoining peripheral edges of the mat are reversed along at least one opposite peripheral edge of the mat such that each half of the mat has at least two adjoining peripheral edges comprised of loops or hooks and the opposite peripheral edges comprised of hooks or loops, and the or each at least one opposite peripheral edge are on one or more respective pairs of sealable tongues, whereby to permit the loop and hook strips of the or each tongues to be folded back lengthwise to permit their insertion between the hook and loop strips of a peripheral edge portion of an adjacent such mat to thereafter permit the hook and loop strips to be pressed together to sealingly connect both mats and form a correspondingly larger composite mat, within which blown air is substantially uniformly distributed and evenly exhausted via their respective exhaust perforations.

With this arrangement, any convenient number of such mats may be quickly connected together to form a composite mat into which the exhaust duct of one or more air blowers can be inserted at any convenient edge portion to provide a generally uniform flow of air, thereby providing a correspondingly uniform drying process. Multiple such mats can therefore be arranged in multiple shapes and connected together to conform to the shape of a room or hallway.

In contrast, the prior art drying mats must use a separate connector for pneumatically connecting a pair of mats together in order to allow blown air from one mat to flow into the other. However, such mats still remain essentially stand-alone mats, each with their own inflatable cavities, therefore providing uneven drying as a result of the use of a tubular connector to transfer blown air from one mat to the other, the collector therefore acting as a throttle to the airflow, and also because there is a blind strip represented by the sealed edges of the mats where they butt together, where no air is being blown onto the floor or wall surfaces.

Preferably, the or each pair of peripheral edge tongues extend outwardly from the major plane of each first and second mat half such that when they are folded back for insertion within an edge portion of another such mat they do so in the manner of a mortise and tenon joint, whereafter both mats can be joined together along a common edge. When folded back for this purpose, each tongue may be temporarily retained in the folded position by connectors such as pairs of press studs and sockets or even pairs of Velcro hook and loop patches or strips fixed to the outer face of each tongue.

Conveniently, the invention also extends to a kit of drying mats of different shapes and sizes whereby to create one or more combination mats tailored to fit a particular floor or wall surface. Such an arrangement is perfectly adapted to the tool hire business where expensive tools and machinery are hired only, when necessary, as opposed to being purchased for use occasionally, given that floods and flood damage and hence the need for drying equipment can be very sporadic and localised. Thus, in the event of a flood occurring within a house of a particular shape and size measurements and calculations can be made to determine the most efficient number and size of drying mats required for the job, which can then be hired and returned after use rather than being purchased and stored unused for long periods.

Accordingly, the invention also extends to a method of drying a room or wall surface, the method including the steps, in any convenient order, of measuring the shape and size of the target area to be dried, selecting a required number of drying mats of various shapes and sizes to fit the target area, connecting the drying mats via their respective hook and loop strips to form a combination drying mat covering substantially the entire target area, inserting the exhaust duct of one or more air blowers into edge portions of the combination mat and thereafter drying the target area in a substantially single operation.

In this patent specification the term “spacer straps” when used to describe the way in which the inside surfaces of the two halves of the mat are permanently connected together is intended to mean any convenient means including webbing or drop-stitch filaments, while allowing air to freely circulate for the purposes of inflating the mat when its peripheral edges are sealed. Similarly, the term “hook and loop” when referring to the means by which edge portions of each mat can be releasably connected together is intended to include any other releasable means for doing so including, without limitation, the use of press studs and associated sockets.

While the main advantage of the drying mat of the invention is its ability to be easily and quickly connected to one or more other such mats to create a combination mat providing uniform airflow to floor or wall surfaces, another advantage is that because the mat does not require a separate tubular connector when being pneumatically connected to another such mat, production costs are reduced and the possibility of the connector being mislaid is eliminated.

### BRIEF DESCRIPTION OF THE SEVERAL VIEWS OF THE DRAWINGS

The invention will now be described, by way of example only, with reference to the accompanying drawings in which:

FIG. 1 is a sectional side view of a drying mat according to the invention in its disassembled condition,

FIG. 2 is a sectional side view of the drying mat of FIG. 1 in its assembled condition,

FIG. 3 is a sectional side view of the drying mat of FIG. 1 arranged for connection to another such drying mat,

FIG. 4 is a sectional side view of a pair of the drying mats of FIG. 1 connected together to form a combination drying mat inflated by an air blower,

FIG. 5 is a plan view of a drying mat of the invention in its stand-alone condition,

FIG. 6 is a plan view of the drying mat of FIG. 4 arranged to be connected to another such drying mat, and

FIG. 7 is a plan view of a pair of such drying mats connected side-by-side to form a larger combination drying mat into one edge of which has been inserted an air blower.

### DETAILED DESCRIPTION OF THE INVENTION

FIG. 1 is a cross-sectional view of a generally two-part flexible drying mat 1 made of PVC where, for clarity, the first, lower, mat half la is shown connected to but separated from the second, upper, mat half 1b by flexible PVC spacer straps 2 ultrasonically welded to respective inner surfaces of each mat half. Extending outwardly from at least one side of each mat half are respective upper lower edge tongues 3, 4. Around the entire periphery of each mat half are strips of hook 5 and loop 6 fastness of the Velcro type, thereby permitting the two halves of the mat to be releasably joined together in this region. However, the hook and loop strips are not arranged uniformly because in the region of the tongues 3, 4 the strips of hooks 5 and loops 6 are reversed, for reasons to be explained. The lower mat half la includes therethrough a large number of perforations 7 through which air can flow.

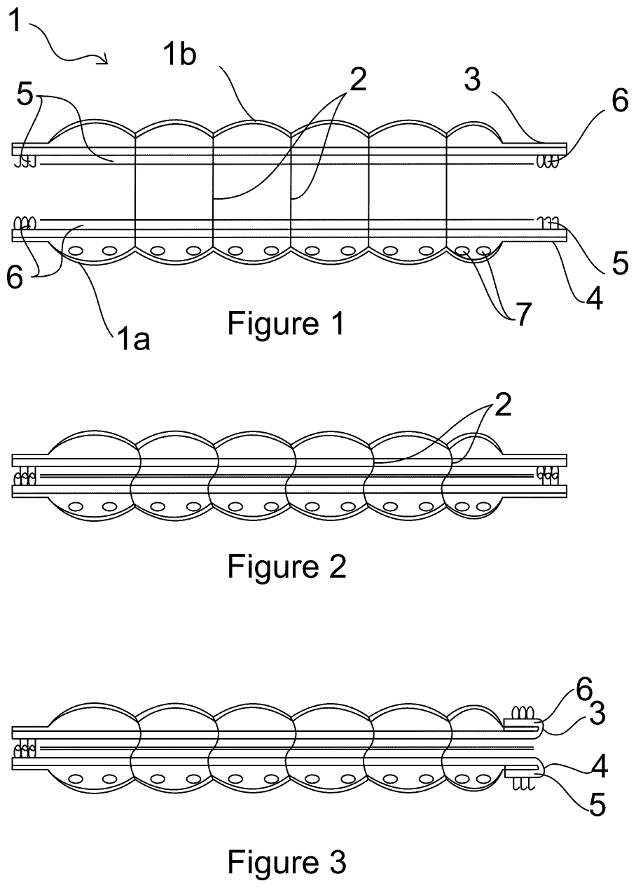

FIG. 2 is a cross-sectional view of the mat shown in FIG. 1 but in which the mat halves 1a, 1b have been pressed together around the entire periphery of the mat by the hook and loop strips 5, 6, thereby allowing the exhaust duct of an air blower (not shown) to be received between them at any convenient point for the purpose of blowing air through the perforations 7.

FIG. 3 is a cross-sectional view corresponding to that of FIG. 2 but in which the edge tongues 3, 4 are shown folded back on themselves, meaning that the hook and loop strips 5, 6 now point in opposite directions corresponding to the directions of the hook and loop strips elsewhere on the mat.

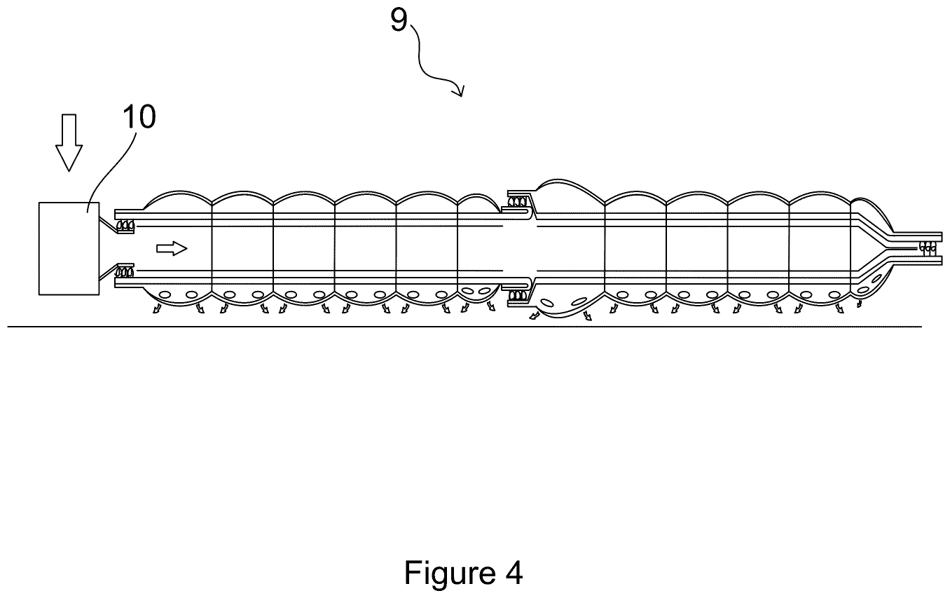

FIG. 4 is a cross sectional view of two such mats joined together to form a combination drying mat and being inflated by an air blower 10. As will be apparent, there is no appreciable obstruction. Of the air as it flows to the opposite end of the combination drying mat, unlike the arrangement shown in D1 where the connector essentially act as a restriction to airflow by forcing the air through a tube of relatively small cross-sectional area. In tests it has been found that relatively uniform drying occurs, and this uniformity can be improved by using two or more air blowers located at strategic edge portions of the combination drying mat. With this arrangement, with open windows or doors providing access to ambient air, room and wall surfaces can be dried more quickly and uniformly as compared to the teaching of D1, while also reducing energy consumption and cost.

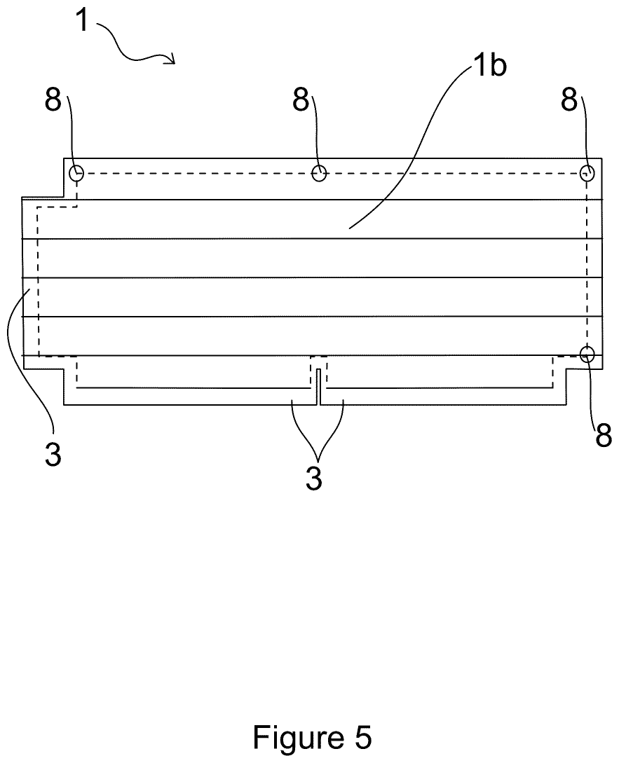

FIG. 5 is a plan view showing the upper half 1b of the drying mat 1, there being a pair of tongues 3 long one major side of the mat and a single tongue 3 on one minor side, all having corresponding tongues 4 (not shown) on the underside of the mat. Around the respectively opposite major and minor peripheral edges of the mat 1 are respective pairs of eyelets 8, one for the other than that of and the other for the lower mat half. These eyelets allow the mat to be hung against a vertical surface such as a wall to be dried but serve no purpose when the mat is being used to dry a floor surface.

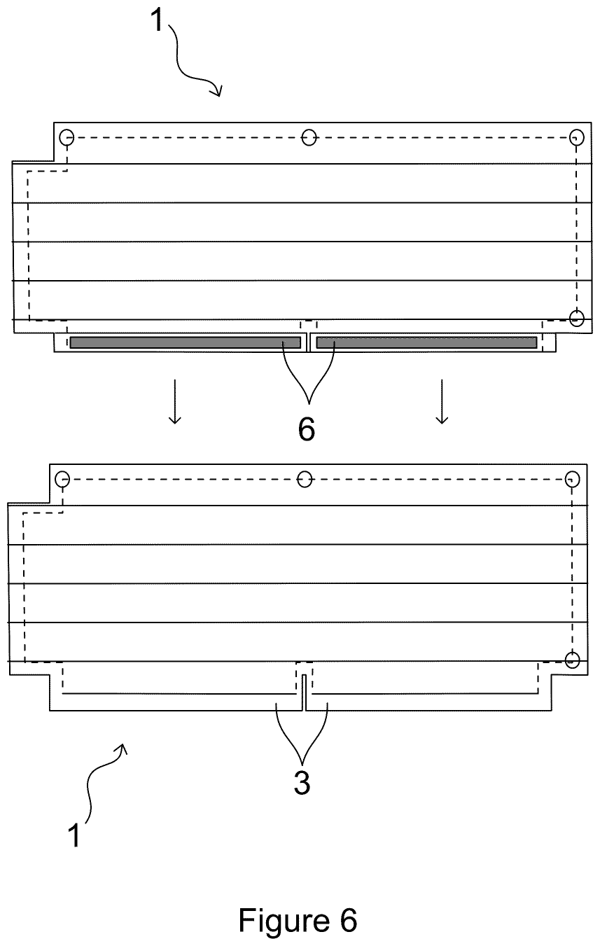

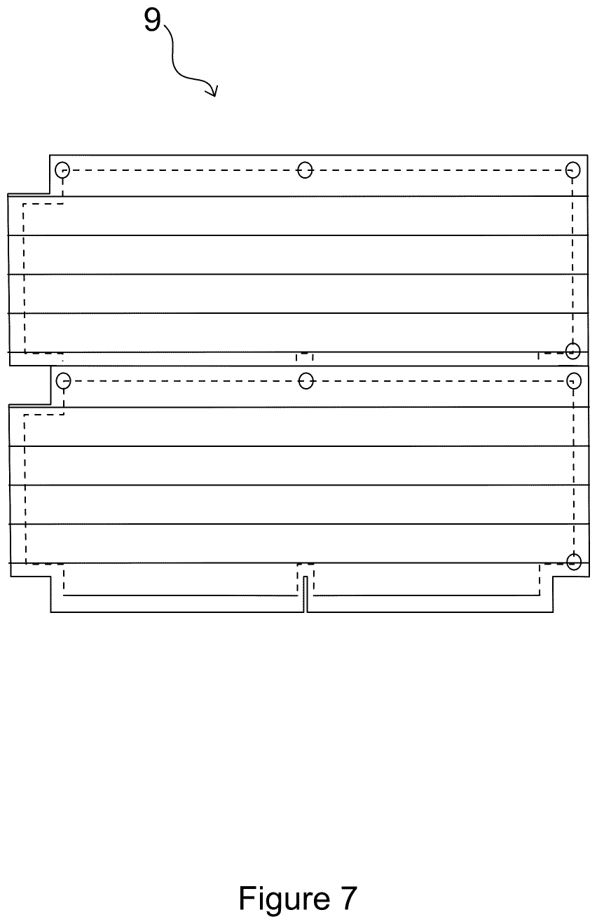

As explained with reference to FIG. 3, the tongues 3, 4 serve the very useful purpose of being able to be folded back on themselves to expose the strips of hooks and loops. FIG. 6 shows a situation where a pair of mats are to be joined together along their respective major edges and, accordingly, the pair of tongues 3, 4 along one side have been folded back to expose the loops 6 and hooks 5 (not shown). These may then be inserted in the manner of a tenon joint between the adjacent such mat in which the peripheral edges of one major side have been separated to expose its own hook and loop strips, thereby enabling both mats to be connected together without any separate connector of the type shown in D1, thereby effectively creating a single combination mat 9 as shown in FIG. 7 capable of providing a uniform flow of air to the floor or wall surface to be dried.

As explained previously, the tongues 3, 4 allow the mat 1 to be connected to one or more adjacent such mats to provide the most efficient shape for any given requirement. Although FIG. 7 shows a pair of such mats joined along the major sides to form a larger, combination mat 9, it will be apparent that the minor sides can be connected end-on-end for use in an “L” shaped room or along a hallway, with no upper limit as to how many such mats can be joined together other than the requirement that sufficient air pressure is maintained by the use of multiple air blowers installed at strategic positions around the periphery.

In contrast, the drying mats described in D1 do not have such flexibility or efficiency and even where a pair of such mats are joined side-by-side the airflow out of the perforations in the first mat is greater and more uniform than in the second mat, whereas by adopting the elegantly simple solution of incorporating foldable tongues on at least one edge of the mat of the invention and reversing the hook and loop strips, each such mat is easily and quickly connectable to another such mat and hence are highly adaptable for stand-alone use or for use in combination with other such mats and one or more air blowers. In turn, given that flood damage to buildings is usually sporadic and unpredictable, requiring urgent attention in order to minimise damage, the ability to quickly and efficiently construct a connected array of drying mats and associated air blowers is an attractive option for those involved in the restoration of flood damaged buildings. This attractiveness may also be increased by the provision of kits of such mats which have a selection of different sizes and shapes such that for the usually complicated floor plan of a building that has suffered flood damage the planning and construction of one or more combination drying mats is made relatively simple as compared to the use of pairs of mats joined together in the manner as shown in D1.

Various embodiments include but are not limited to the following.

The invention comprises an inflatable drying mat (1) for use with an air blower of the type having an air exhaust duct, the mat comprising a first, lower, half (1a) having a plurality of exhaust perforations (7) through which air can be blown to dry floor or wall surfaces, and a substantially air impermeable second, upper, half (1b). The first half and the second half are connected together by a plurality of spacer straps (2) enabling the drying mat to retain a generally planar shape when inflated. The first half and the second half are connectable together around their peripheral edges by hook (5) and loop (6) strips for releasably sealing the peripheral edges of the mat while allowing access to the exhaust duct of the air blower to permit inflation of the mat. The invention is characterised in that the hook (5) and loop (6) strips along at least two adjoining peripheral edges (8a, 8b) of the mat are reversed along at least one opposite peripheral edge (8c, 8d) of the mat such that each half of the mat has at least two adjoining peripheral edges comprised of loops or hooks and the opposite peripheral edges comprised of hooks or loops, and the or each at least one opposite peripheral edge (8c, 8d) are on one or more respective pairs of sealable tongues (9), whereby to permit the loop and hook strips of the or each tongues to be folded back lengthwise to permit their insertion between the hook and loop strips of a peripheral edge portion of an adjacent such mat to thereafter permit the hook and loop strips to be pressed together to sealingly connect both mats and form a correspondingly larger composite mat, within which blown air is substantially uniformly distributed and evenly exhausted via their respective exhaust perforations.

The drying mat may be further characterised in that two adjoining peripheral edges (8a, 8b) are provided with hook and loop strips at their edges and two adjoining peripheral edges include tongues with respectively opposite loop and hook strips thereon whereby to permit, when such tongues are folded back lengthwise, connection to other such mats.

In addition or in the alternative, the drying mat may be further characterised in being generally rectangular, having major sides and minor sides characterised in that one of the major sides includes a pair of tongues and one of the minor sides includes a single tongue, each of which tongues having hook and loop strips arranged in reverse order to the hook and loop strips of their respectively opposite peripheral edges.

In further addition or in the alternative, the drying mat according to any preceding claim further characterised in that each tongue includes one or more releasable fasteners, such as strips of Velcro or press studs and sockets, permitting the tongue to be retained in its folded back position prior to insertion into an edge portion of an adjacent such mat.

A kit of mats as described above, the kit including mats of different sizes and shapes whereby to permit the selection and construction of one or more combination mats tailored to fit the floor or wall surfaces of flood-damaged buildings.

A method of drying a floor or wall surface, the method including the steps, in any convenient order, of selecting a required number of drying mats according to any preceding claim of various shapes and sizes to fit the target area, connecting the drying mats via their respective hook and loop strips to form a combination drying mat covering substantially the entire target area, inserting the exhaust duct of one or more air blowers into edge portions of the combination mat and thereafter drying the target area in a substantially single operation.

1. An inflatable drying mat for use with an air blower of the type having an air exhaust duct, the mat comprising a first, lower, half having a plurality of exhaust perforations through which air can be blown to dry floor or wall surfaces, and a substantially air impermeable second, upper, half, the first half and the second half being connected together by a plurality of spacer straps enabling the drying mat to retain a generally planar shape when inflated, the first half and the second half being connectable together around their peripheral edges by hook and loop strips for releasably sealing the peripheral edges of the mat while allowing access to the exhaust duct of the air blower to permit inflation of the mat, wherein the hook and loop strips along at least two adjoining peripheral edges of the mat are reversed along at least one opposite peripheral edge of the mat such that each half of the mat has at least two adjoining peripheral edges comprised of loops or hooks and the opposite peripheral edges comprised of hooks or loops, and the or each at least one opposite peripheral edge are on one or more respective pairs of sealable tongues, whereby to permit the loop and hook strips of the or each tongues to be folded back lengthwise to permit their insertion between the hook and loop strips of a peripheral edge portion of an adjacent such mat to thereafter permit the hook and loop strips to be pressed together to sealingly connect both mats and form a correspondingly larger composite mat, within which blown air is substantially uniformly distributed and evenly exhausted via their respective exhaust perforations.

2. A drying mat according to claim 1, wherein the at least two adjoining peripheral edges are provided with hook and loop strips at their edges and two adjoining peripheral edges include tongues with respectively opposite loop and hook strips thereon whereby to permit, when such tongues are folded back lengthwise, connection to other such mats.

3. A drying mat according to claim 2, comprising a rectangular shape, having major sides and minor sides, where one of the major sides includes a pair of tongues and one of the minor sides includes a single tongue, each of which tongues having hook and loop strips arranged in reverse order to the hook and loop strips of their respectively opposite peripheral edges.

4. A drying mat according to claim 3, wherein each tongue includes one or more releasable fasteners, permitting the tongue to be retained in its folded back position prior to insertion into an edge portion of an adjacent such mat.

5. A drying mat according to claim 4, wherein the one or more releasable fasteners is selected from the group consisting of strips of Velcro, press studs and sockets.

6. A drying mat according to claim 1, wherein each tongue includes one or more releasable fasteners, permitting the tongue to be retained in its folded back position prior to insertion into an edge portion of an adjacent such mat.

7. A drying mat according to claim 2, wherein each tongue includes one or more releasable fasteners, permitting the tongue to be retained in its folded back position prior to insertion into an edge portion of an adjacent such mat.

8. A kit of mats according to claim 1, the kit including mats of different sizes and shapes whereby to permit the selection and construction of one or more combination mats tailored to fit the floor or wall surfaces of flood-damaged buildings.

9. A kit of mats according to claim 2, the kit including mats of different sizes and shapes whereby to permit the selection and construction of one or more combination mats tailored to fit the floor or wall surfaces of flood-damaged buildings.

10. A kit of mats according to claim 3, the kit including mats of different sizes and shapes whereby to permit the selection and construction of one or more combination mats tailored to fit the floor or wall surfaces of flood-damaged buildings.

11. A kit of mats according to claim 4, the kit including mats of different sizes and shapes whereby to permit the selection and construction of one or more combination mats tailored to fit the floor or wall surfaces of flood-damaged buildings.

12. A method of drying a floor or wall surface, the method including the steps, in any convenient order, of selecting a required number of drying mats according to claim 1 of various shapes and sizes to fit the target area, connecting the drying mats via their respective hook and loop strips to form a combination drying mat covering substantially the entire target area, inserting the exhaust duct of one or more air blowers into edge portions of the combination mat and thereafter drying the target area in a substantially single operation.

13. The method of claim 12, wherein the at least two adjoining peripheral edges are provided with hook and loop strips at their edges and two adjoining peripheral edges include tongues with respectively opposite loop and hook strips thereon whereby to permit, when such tongues are folded back lengthwise, connection to other such mats.

14. The method of claim 13, wherein the drying mats comprise a rectangular shape, having major sides and minor sides, wherein one of the major sides includes a pair of tongues and one of the minor sides includes a single tongue, each of which tongues having hook and loop strips arranged in reverse order to the hook and loop strips of their respectively opposite peripheral edges.

15. The method of claim 14, wherein each tongue includes one or more releasable fasteners, permitting the tongue to be retained in its folded back position prior to insertion into an edge portion of an adjacent such mat.

16. The method of claim 15, wherein the one or more releasable fasteners is selected from the group consisting of strips of Velcro, press studs and sockets.
